(19) United States
(12) Patent Application Publication
(10) Pub. No.: US 2003/0205623 A1
(43) Pub. Date: Nov. 6, 2003

(54) Method of manufacturing a card with anti-counterfeit differentiable mark

(76) Inventors: Chih-Yang Huang, Taoyuan Hsien (TW); Tsung-Chao Li, Taoyuan Hsien (TW); Wen-Liang Yeh, Hsin Chu Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/136,299

(22) Filed: May 2, 2002

(51) Int. Cl. G06K 19/06

(52) U.S. Cl. 235/494

(57) ABSTRACT

The invention provides a method of manufacturing a card such as bankcards provided with an anti-counterfeit differentiable mark. A stamper is fabricated by engraving and plate-making methods, the stamper being engraved with a feature pattern provided by a client, such as bank logo and trademarks. The feature pattern of the stamper is transferred onto a surface of a card by injection molding. A metallic layer is formed on the card by plating. A printing layer is finally formed on the card by printing. Hence fabricated, the card is provided with a text and/or graphics pattern similar to the effects of a hologram pattern.

### BACKGROUND OF THE INVENTION

1. Field of the Invention

The invention relates to a method of manufacturing a card provided with anti-counterfeit differentiable mark. More particularly, the invention provides a method of manufacturing cards such as bankcards by particularly molding anti-counterfeit differentiable marks.

2. Description of the Related Art

Fraudulent uses of bankcards are often due to insufficient anti-counterfeit measures taken in the fabrication of the bankcards and fraudulent records of the card codes. Presently, anti-counterfeit measures implemented in the fabrication of credit cards are hologram patterns, micro text printing, and invisible ink printing.

However, the above traditional anti-counterfeit measures are insufficient. If only the hologram patterns are fraudulently obtained, a counterfeited card then can be easily fabricated by conventional card manufacturing techniques (pressing and printing techniques). In addition, provided consumer card codes are fraudulently recorded and passed to fraudulent organizations, perfect card counterfeits hence can be achieved, causing prejudicial damages to both consumers and bank corporations.

The above traditional anti-counterfeit measures thus are insufficient and need to be improved.

### SUMMARY OF THE INVENTION

It is therefore an object of the invention to provide a method of manufacturing a card with anti-counterfeit differentiable mark that provides the card with texts and/or graphics patterns similar to hologram effects in addition to various anti-counterfeit measures known in the art. Card counterfeiting is thereby more difficult to achieve.

To accomplish the above and other objectives, a card manufacturing method of the invention comprises the following steps. A stamper is fabricated by engraving and plate-making methods, the stamper being engraved with a feature pattern provided by a client, such as bank logo and trademarks. The feature pattern of the stamper is transferred onto a surface of a card by injection molding. A metallic layer is formed on the card by plating. A printing layer is finally formed on the card by printing.

To provide a further understanding of the invention, the following detailed description illustrates embodiments and examples of the invention, this detailed description being provided only for illustration of the invention.

### BRIEF DESCRIPTION OF THE DRAWINGS

The drawings included herein provide a further understanding of the invention. A brief introduction of the drawings is as follows:

FIG. 1 is a flow chart of a method of manufacturing a card with anti-counterfeit differentiable mark according to an embodiment of the invention; and

FIG. 2 is a schematic perspective view of a card structure manufactured according to an embodiment of the invention.

### DETAILED DESCRIPTION OF THE EMBODIMENTS

Wherever possible in the following description, like reference numerals will refer to like elements and parts unless otherwise illustrated.

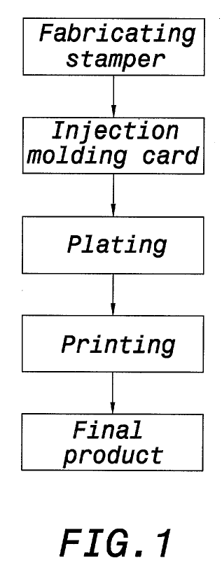

Referring to FIG. 1, the invention provides a method of manufacturing a card with anti-counterfeit differentiable mark. The method of the invention, suitable for manufacturing various types of cards such as credit cards or cash retrieval cards comprises the following steps.

(a) Fabrication of the stamper: the client provides a feature pattern. The feature pattern differs according to different banks, the feature pattern can be, for example, texts and/or graphics. Via optical disc engraving and plate-making methods, the feature pattern is engraved on the stamper.

(b) Card injection molding: via placing the stamper on the mold, the feature pattern of the stamper is transferred onto a surface of the card body through injection molding, the card body being made of transparent plastics.

(c) Plating: with the feature pattern protruding from the card, a metallic layer is formed on the surface of the card by plating to increase its reflective effect.

(d) Printing: a printing layer according to the demand of the client is printed on the card surface, hence achieving the manufacture of the card with anti-counterfeit differentiable mark.

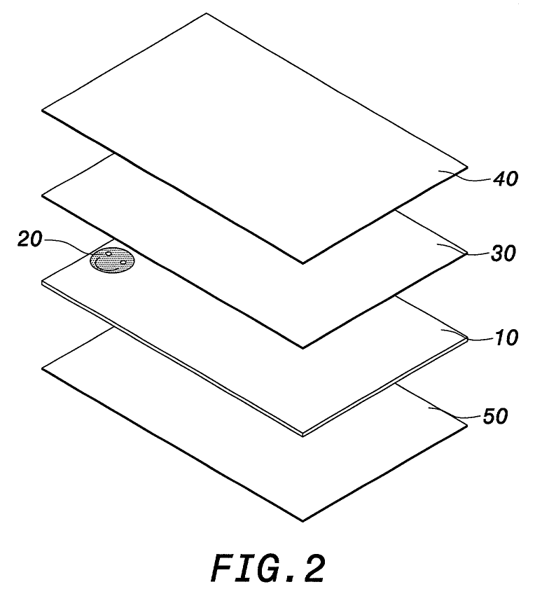

Referring to FIG. 2, another schematic view illustrates the method of manufacturing a card with an anti-counterfeit differentiable mark. As illustrated, the method of the invention transfers a feature pattern 20 from the stamper onto the surface of the card body 10 by injection molding. By plating, a metallic layer 30, for example an aluminum layer, is formed on the surface of the card. Printing layers 40, 50 are further printed on the upper and lower surface of the card, hence achieving the card with anti-counterfeit differentiable mark of the invention.

Hence manufactured, the card of the invention is provided with text and/or graphics patterns such as bank logo or trademarks that are similar to the effects of hologram patterns, in addition to various anti-counterfeit measures known in the art. Card counterfeit thereby is more difficult to achieve.

Furthermore, traditional pressing methods use manufacturing equipment that allow a line production of the cards. In contrast, the method of the invention requires an equipment of injection molding that results in a substantially high manufacturing cost. In addition, the design of the mold, the manufacture of the stamper requires expert artisan, which adds to the difficulty of card counterfeiting. The invention therefore improves the disadvantages of the traditional manufacturing methods by rendering card counterfeiting more difficult, thereby reducing economical damages of the banks and consumers.

It should be apparent to those skilled in the art that the above description is only illustrative of specific embodiments and examples of the invention. The invention should therefore cover various modifications and variations made to the herein-described structure and operations of the invention, provided they fall within the scope of the invention as defined in the following appended claims.

What is claimed is:

1. A method of manufacturing a card provided with an anti-counterfeit differentiable mark thereon, the method comprising:
(a) fabricating a stamper by engraving and plate-making methods, the stamper being engraved with a feature pattern provided by a client;
(b) transferring the feature pattern of the stamper onto a surface of a card by injection molding;
(c) forming a metallic layer on the card by plating; and
(d) forming a printing layer on the card by printing.

2. The method of claim 1, wherein the feature pattern is texts and/or graphics.

3. The method of claim 1, wherein the card is made of transparent plastics.

4. The method of claim 1, wherein the metallic layer is an aluminum layer.
